(19) United States
(12) Patent Application Publication
(10) Pub. No.: US 2010/0294894 A1
(43) Pub. Date: Nov. 25, 2010

(54) Sonic boom overpressure to minimize uncontrolled movement, to prevent smuggling and for border or site location control

(76) Inventor: John Choate, Stamford, CT (US)

Correspondence Address: Mr. John Choate, P.O. Box 9949, Arlington, VA, 22219-9949, US

(21) Appl. No.: 12/662,978

(22) Filed: May 14, 2010

Related U.S. Application Data
(63) Continuation-in-part of application No. 11/800,810, filed on May 8, 2007, now abandoned.

(51) Int. Cl. B64C 30/00

(52) U.S. Cl. 244/4 R

(57) ABSTRACT

A method to generate air overpressure to control borders, minimize or stop uncontrolled or unauthorized movement, occupation, or transit of locations along short or long borders, disrupting or stopping smuggling of unwanted material or people with static or nonstatic operations or impediments, and creating non lethal movement and impact, improving the area of coverage, improving the speed with which interruption may be accomplished, providing a more economical method for blind detection, and allowing repetitive treatments over the same locations.

### CROSS REFERENCE TO RELATED APPLICATIONS

This application is a continuation-in-part of U.S. patent application Ser. No. 11/800,810, filed May 8, 2007, the entirety of which is incorporated herein by reference.

### PRESERVATION OF COPYRIGHT

Pursuant to 37 CFR 1.71(e): A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. All rights reserved. Copyright 20107.

### BACKGROUND OF THE INVENTION

1. Field of the Invention

The present invention is directed to using non-lethal energy, to wit the sonic boom, or atmospheric overpressure, in combination with seasonal heat or cold.

2. Description of the Prior Art

The method for minimizing or stopping uncontrolled or unauthorized movement, occupation, or transit of locations along short or long borders, has relied on static trenches, walls, fences, guards, threats, mines, explosives, moats, briars, thistles, logs, lights and weapons. Other methods include disrupting or stopping smuggling of unwanted material or people with static or nonstatic operations or impediments.

These walls are as old and long as the Great Wall of China, circa fourth century B.C. or Trojans or Hadrians wall in the first century A.D. in northern Britain to keep out the Scots. The ‘Berlin Wall’ during the cold war was to keep people inside the wall, which ran from the Baltic to the Black Sea. Rivers, natural moats, have been borders between nations and people, such as the Danube between the Roman Empire and the northern tribes, or the Rhine between Gaul and the Germanic tribes. The English channel was described by Churchill as an anti tank moat, during the Battle of Britain in World War Two. Another wall during World War Two was infamous for its failure, the Maginot line, France's defense against the Hun, was outflanked and became the poster child for futility of static defenses. Mountain ranges serve as natural walls and natural borders. But static restrictions have limitations, in that they are static. Their purpose is to slow, delay, retard movement, increase expense and inconvenience of movement, allowing point reinforcement as required.

Smuggling defenses use nonstatic defenses such as airplanes or helicopters, which are primarily used for observation or tracking.

The use of the Sonic Boom has not been attempted for in either an offensive or defensive capacity in border or smuggling control. Directed energy weapons are attempts to use lasers and high frequency waves to concentrate energy. These have yet to be used to reduce effectiveness of explosives and ordinance, or movement. They are limited in reach so as to be inconvenient and expensive for border control.

Mines

The method for clearing mine fields included tanks with chains thrashed ahead of the vehicles, attempting to create the sufficient impact to detonate the ground ordinance and explosives. Other methods included using metal detectors, including magnetic sensors seeking iron and steel, to identify explosives. These have reduced success for plastic explosives, hydrogen peroxide based explosives, and fertilizer and ammonia based explosives, which have no ferrous or metallic components. Much of the anti IED research has been focused on detecting, locating, identifying the IED before explosion, whereupon it can be detonated by gun fire, or perhaps attempts can be made to disarm the device without explosion. The difficulty has been in finding the weapons, which can be hidden anywhere along thousands of miles of roads, or transported in cars or trucks or boats, worn on human bodies, tucked in brief cases, carried in paper sacks, strapped to bicycles, or in any other manner.

Popular in the 1950s were the “cap” pistols, sold as toys to children, who could buy red tapes with tiny amounts of gunpowder glued to the tape which would pop with a sound when the hammer of the toy pistol was tripped by the finger release. If you didn't have a cap pistol, or it was broken, you could do the same, that is get the pop sound, by taking a hammer and smashing the black dot gunpowder on the red tape against the sidewalk. The hammer blow did not crack concrete, yet it exploded the tiny charge of powder in the cap. The hammer also was on the cap pistol, to make the pop sound. If this force could explode black powder, with less force than required to crack concrete, the additional, more powerful force should be able to cause detonation or ignition. This principle applies to the charge for ammunition, striking the base of the shell with a hammer which causes pressure to explode the gunpowder, releasing gases to propel the lead bullet or other projectile. The fast creation and release of gases is also the principle for rockets.

Among these are improvised explosive devices, made from dynamite, artillery shells, blasting caps, gunpowder, diesel and fertilizer, hydrogen peroxide and methane, gasoline, phosphorous, grenades, plastics and other chemicals which have flammable or explosive properties. Nitro glycerin was discovered as an alternative to gunpowder, and when combined with inert products to create dynamite, it has many worthwhile uses in mining or construction. But in war, explosives become weapons. By burying explosives near roads, the trap can be activated by cell phones or garage door openers, or any wireless or radio means to send a signal to detonate the IED. Because they have been buried, or disguised, or camouflaged, many go undetected, much as the buries land mines used in previous wars.

Many solid explosives are subject to detonation by a small blast, such as a blasting cap, or shock, such as striking with a hammer. Indeed, the mechanism for a pistol or rifle which hits the bullet, is called the hammer, which jams the firing pin against the shell casing. Gunpowder and muskets were imagined as the creations of Gods by native people unfamiliar with the chemistry. Hence the mythic God Thor, used a giant hammer to create sparks and thunder, as in a thunder storm. The noise of the musket and possible flash of flame was reminiscent of lightning and thunder. Thunder is caused by lightning breaking the sound barrier, moving faster than the speed of sound.

Mines have been used for centuries in war. During World War II, in order to clear mine fields, tanks were mounted with swinging chains which would flog the ground in front of the tank with the expectation the sudden striking would detonate mines, and clear paths through mine fields. The process was limited by the speed of the tank, the length of the chains, and width of the tracks or arms managing the chains. Other means to locate mines were metal detectors, seeking differences in density of ground, assuming iron to be denser than dirt, or gaining reading for magnetic differences when compasses came near iron containers.

Legal Issues

Legal issues include the Geneva conventions on weapons, such as mines. Generally, weapons which cannot be controlled or called back, or rendered harmless, are “illegal”. These would include biologics, which are released into the atmosphere and will attack upon whoever and wherever the wind blows. Another example are ocean mines, breaking lose from their anchors and floating on the waves until they reach a shore or ship, whether friend or foe. The destruction and control of these explosives, if it can be effectuated simply, and economically, would further international law.

For the sonic boom, efforts have been made to reduce the shock of the aircraft. This patent requires the maximum shock of the sonic boom, as is explained within.

Natural phenomena create sonic booms, the most common of which is lightning, which also generates a substantial electromagnetic pulse. Other natural phenomena which break up ice flows is the spring thaw due to increase heat. Another phenomena which would destroy crops at the time ripe for harvest would be a hail storm, such as one around Paris when the wheat crop for 1787 was destroyed by hail.

### SUMMARY OF THE INVENTION

It is an object of the present invention to provide a method to intercept smugglers, disrupt prohibited activity along borders, roads, or areas wherein activity needs to be controlled in an efficient fast flexible economical manner

provide a method to protect military personnel from roadside bombs, to destabilize car bombs, to destabilize suicide bombers, and to ignite an enemy's explosives outside of their control, the method comprising the steps of: Obtaining a heavier than air flying machine,

of sufficient girth and size to generate the sufficient minimum overpressure,

controlling its flight path,

advancing its speed beyond the sound barrier,

operating it at a sufficiently low altitude above the target space to generate overpressure of a pound per inch,

monitoring the machine's path to return it safely,

cover as many areas, linear miles of ground as available,

in as brief time span, short enough to prevent protection of the targeted property.

### BRIEF DESCRIPTION OF THE DRAWINGS

FIG. 1 is a table of how fast the detonated high explosive shock wave will reach the sonic boom delivery vehicle or aircraft.

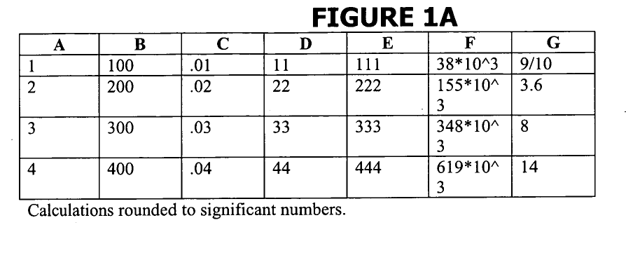

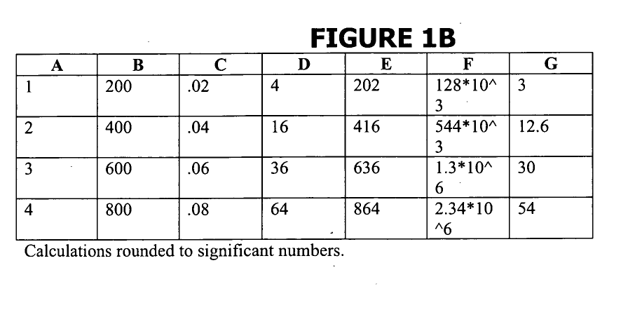

### DETAILED DESCRIPTION OF THE INVENTION

Interruption of transit along borders or reduction or prohibition of smuggling.

Guarding long borders, year around, in all seasons, day and night, has been a challenge of mankind for generations. Keeping people out. Keeping people in. Prohibiting contraband, black market, bartering. Every means have been attempted. Water, mines, walls, fences.

A sonic boom can be moved to the location best situated for accomplishing the means of controlling ground level activities. The overpressure can disrupt or roll cars and trucks, uproot trees, or crack concrete. This would disrupt operations, probably most effectively at night, to prevent smuggling, or control borders, or delay, retard, prohibit movement, or increase expense or inconvenience, until relief can arrive for point reinforcement.

### Detonation of Explosives

Detonation and ignition are combinations of force, or temperature, or energy charge, or all three. For instance, the higher the temperature, the more unstable explosives become, and the less striking force, or other energy, is required for detonation. Thus in a desert environment, wherein day time temperature may be 130 degrees Fahrenheit, the day time may present preferred conditions for clearing mines by explosion. Or, the reverse, when night conditions reduce the temperature to the 40s to 60s, and more force is required for detonation, some explosive objects may be preserved, and others detonated. At temperatures below freezing, the air is denser still, and more pressure will be created by the sonic boo. Thus such explosives as are susceptible to a combination of elevated heat and pressure may be forced during the day in summer, and others which are susceptible to more pressure and less heat, may be forced at night, or in winter. The sonic boom provides readily available means to distinguish between the force to destabilize and explode various chemicals, of a low or high explosive and reactive composition.

Likewise, soil conditions are affected by temperature. Perhaps, frozen soil will transmit the boom force deeper into the soil, than loose sand, or non frozen ground. Transmission of the overpressure force will vary between solids and liquids, whether in ground, in living things, the air, or water.

Also, sonic boom may be useful to break up ice which seasonally blocks ports or rivers or locks in the inland waterway. The alternative being ships and hammers which are sent onto the ice with the risk of falling through the ice, when it breaks, and covering substantially reduced areas, allowing water to refreeze at the beginning before the end is completed.

### Sonic Boom

The United States military, since the early days of World War Two, has generally commanded the air space over battlefields, cities, countries, oceans and polar regions. Because of the Air Power superiority, enemy forces have adapted to urban tactics, if not to defeat the Air Power, certainly to render economies and governments unstable by doubt and fear caused by random bombing and attacks. One belief widely held, was that a “sound barrier” existed which prevented any safe or controlled travel faster than the speed of sound. About 1947, man had its first, controlled speed flight faster than sound with Air Force Officer Chuck Yeager as the test pilot. This was the first known recorded sonic boom, as others caused by lightening or explosions, were of unknown causes.

Concerned with the long term affects of the “sonic boom”, the United States Government tested sonic booms over populated areas, specifically Oklahoma City Okla. in the mid 1950s. Several things were learned. Sonic booms were not lethal to man, at several miles distance, any more than the thunder of a lightning strike. A loud noise, to be sure, but not lethal. Nor was it lethal to most animals, if not all, such as birds, stock animals, creeping things, fish, or pets.

Other studies identified the strength of sonic booms in the over pressure of the air caused by the speed and proximity of the source of the boom. Thus sonic booms have been able to crack concrete blocks, much in the same manner as a sledge hammer might so do. Booms can crack plaster, glass, or other rigid, and inflexible solids. The booms do less, little, or no damage to flexible products such as trees, water, or sand. However, a boom could cause a house to implode, much as a tornado would cause it to explode, if the difference between inside and outside atmospheric pressure were great enough. The standard for transportation in commerce for many explosives is to be able to withstand the shock of the twelve meter drop test, that is dropping the explosive from 12 meters, about 40 feet or a 4 story building. The energy is about that of a real good whack with a sledge hammer to crack concrete.

Combining the need to control borders and stop smuggling, identify IEDs and render them less harmful or safe, with the ability of sonic booms to act as rolling hammers, means that sonic booms could make life hard for smugglers, detonate armed artillery shells, dynamite, and other explosives which are sensitive to pressure and striking. The booms may be safer and economically preferred to other means to control borders, identify mines and booby traps, and IEDs.

Means: The delivery of the sonic boom could be performed by airplane, manned or unmanned, or rocket, presumably unmanned. The drone would fly along roads or areas which need to be checked, pulling an invisible but very real sonic boom behind. At a height of 100 yards, and a speed of Mach 3, the drone could cover a mile every two seconds, with enough overpressure to crack curbs or pavement, or frozen water.

Another version is to create a stationary sonic boom generator, such as a jet engine as the propelling engine on a fixed rigid support, attached to a central axle, wherein the edge of the outer attachment whirls in a circle faster than the speed of sound, traveling at about 1100 feet per second. A circle with a radius of about 175 feet, with an engine propelling around the circumference of the circle every second would create a sonic boom.

Another use is to destabilize snow accumulations so as to generate controlled avalanches. The mountainous regions often rely on tourist activity for economic growth to sustain year around employment, hospitals, and settlement. In the winter time, snow falls measured in dozens of feet occur at higher elevations. The snow can accumulate until it weighs many hundreds or thousands of tons, usually measured as a foot of snow weighing the same as, or being equivalent to, an inch of water. The snow can and will melt, and slide as conditions permit. Thus in tourist or snow skiing or snow boarding areas, park observers or rangers attempt to reduce the accidental but expected collapse of snow, by generating avalanches. This is done by creating noise, by firing blanks from exploding shells. The noise is also supersonic. Usually these noise generating machines are located in a single location, giving a circular energy pattern which can be miles from the targeted snow fall. Better is to have a drone or air vehicle flying through the passes to create the overpressure of a sonic boom to knock off the snow, if it is to fall anyway.

Another use is to harvest nuts and tree products such as walnuts, pecans, and other tree born nuts. Present harvesting consists of waiting for a frost, spreading out a tarp under the tree, and waiting for the wind to knock the nuts to the ground. To speed up the fall of nuts, long poles are used to reach to the limbs and vibrate them by knocking the pole into the limb. It is this knocking which could be done by the over pressure of the sonic boom. The advantage to the boom is it would cover the entire field in a relatively short time, rather than have the poles knock individual branches on a tree, which branches number in the hundreds or thousands.

Another use is to interrupt, destabilize, or explode, floating or surface located water placed mines. For mines on the surface of a lake, sound, sea, or ocean, the strong tap of the sonic boom would be like a sledge hammer. For those mines which are triggered by touch,—contact mines—as opposed to magnetic, or some other means of detonation, the sonic boom would be an overpressure which would activate the mine, like the brushing of a ship. For mines located 10 or 20 feet below the surface, the sonic boom would have proportionately less effect, the deeper the location of the explosive.

Booms have been created and measured which were capable of one pound per square inch, whereas only 2.3 ounces per square inch will shatter some glass. Because the duration is so brief, the energy range is concentrated below gunfire and industrial noise which is advantageous in an urban setting, if hundreds or thousands of persons were exposed to the energy.

Think of the Sonic boom as a reverse directed energy weapon. Instead of a focused laser beam or particle ray, it is an expanded breath of air laying a carpet, pressing down on the ground. Because the sonic boom cone presses down, it would be useful in fire prevention or fire fighting by breaking off fire compromised trees, limbs, fuel, grasses, so they did not become air borne embers to carry the fire past fire breaks.

Dry gun cotton is sensitive to shock. The ATF maintains a list of explosives, which includes over two hundred chemical compounds.

### Limitations:

Some explosives are less or not vulnerable to pressure detonation, such as plastic explosives. Plastics usually require an electrical impulse, or heat. Plastics were developed to have more stability in handling and transit. Thus the sonic boom may not be effective to detonate the plastic explosive, but only to perhaps knock it out of someone's hand or dislodge it from an insecure resting place.

Accommodation: Urban areas in war zones would have to accommodate by removing windows to avoid glass breakage.

The size of the supersonic transport affects the length of the sound, and hence its energy. Thus a bullet or shell, while traveling at supersonic speeds generate a sonic boom, the size is too small to generate the overpressure required to destabilize an explosive. Thus multiple aircraft flying in formation would create a large enough front to create the boom to crack concrete. An example is a 100 ton jetliner, or even a space shuttle rocket size vehicle. These could be drones, operated by remote control, to fly at low levels, 100 feet above the terrain is probably optimal. Tests comparing overpressure note the Concorde with twice the overpressure as military jets.

The size of the sonic boom cone is a factor of height above ground—1,000 feet altitude produces a cone about a mile wide, or 5 times as wide as the altitude. Each 1,000 feet adds a mile, and a 50,000 foot altitude has a cone of 50 miles. Of course, the energy is reduced as a product of a square of the distance from the generating aircraft source. Thus at an altitude of 100 feet, the cone would be about 500 feet wide, or two football fields wide. If a cone were desired of 1200 feet radius (2400 feet wide), the altitude would be 500 feet. However the overpressure would decline to about a fourth of the overpressure at 100 feet. This may still be sufficient for clearing mines and IEDs along roads, highways, right of ways, by pushing back, and away from the middle of the road, the location for depositing explosives. One standard sought by the military has been to be able to locate IEDs at the rate of 2,700 square meters every second, or 28 thousand square feet, or two thirds of an acre per second. A sonic boom cone, from an altitude of 100 feet, can shock the ground with an overpressure that will break concrete, at the rate of half million square feet or 51 thousand square meters, per second, or about 12 acres a second.

Weather: The temperature of the air, turbulence, direction of travel, pressure and speed of the transport are additional factors. Thus a cold day, with heavier air pressure, would increase the overpressure level. On a hot day, the ground temperature would have reduced the stability of most explosives, but the overpressure, other things being equal, would be less, because the air is less dense. Pictures have been taken of aircraft passing through the sound barrier.

A high explosive shock wave, created by gas expansion and the releasing of enormous amounts of energy, can travel as fast as a 10 kilometers a second. The sonic boom will still travel at the speed of sound. In order to avoid a high explosive shockwave from catching up with the air vehicle generating the sonic boom, the air vehicle should travel at speeds sufficient to stay ahead, even as fast as Mach 30, in straight low flight. This is over 22,000 miles per hour which is the speed of the space shuttle and exceeds the speed needed to leave the gravitational attraction of the earth. This speed will cause friction heating of the vehicle, as noted on reentry by space vehicles or meteors entering the earth's atmosphere. However, the distance with which this high explosive, high speed shock wave, expends its energy is seldom more than a few hundred meters in radius. A means is available to allow the aircraft to receive the push from the shock wave coming from behind without losing aerodynamic control. If that is not possible, then expendable drones would be used, flying at Mach speeds well under the shock wave, and accepting the crash and loss of the drone, if a shock wave from the detonation of a high explosive wrecked its flight. The point is drones can be expendable to save lives of soldiers.

The Impact necessary to cause a detonation is measured bullet impact sensitivity, which have test standards for ammunition. Explosives have tests as described in the code of federal regulations.

Thus, this invention uses the sonic boom, to increase atmospheric overpressure, in a targeted, measurable, controlled manner, in a relatively short amount of time, to cover a large area, to avoid lethal consequence to animal, plant, and human population, in order to:

1) disrupt smuggling

2) control borders

3) prevent interference

4) explode chemicals and weaponry relatively subject to shock,

5) crack ice flows to open water channels,

6) crack solids such as concrete,

7) disperse refuse accumulating in ice in water channels,

8) detonate land and water surface mines,

9) impair or reduce strength of brittle items, such as concrete bridges, or overpasses,

10) generate avalanches, reducing danger of surprise destruction, assisting tourist and winter sport safety,

11) harvest nuts, walnuts, pecans, tree nuts,

12) avoid lethal consequence to animal, plant, and human population.

13) free from electromagnetic pulse or jamming of radios, communications,

14) able to “clear” ten times the acreage of LEDs as compared to other directed energy weapons,

15) able to clear the same acreage of other directed energy weapons in ten times faster,

16) able to provide threshing when wheat or grain crops are ripe for the harvest (requires a ground cover to save the grain).

What is claimed is:

1. A method to control ground level activities, the method comprising:
creating an atmospheric overpressure shock in a targeted area by navigating a ground level disturbing device at supersonic speeds, said atmospheric overpressure shock being sufficient to prevent the occurrence of ground level activities.

2. A method for disrupting smuggling, the method comprising:
using an aircraft flying at supersonic speeds and at low altitudes to create an atmospheric overpressure at ground level so as to impede vehicle movement.

3. The method of claim 2, wherein the method is used to prevent vehicle movement by smugglers near a political boundary.

4. The method of claim 2, wherein the atmospheric overpressure is sufficient to stop vehicle movement.

5. The method of claim 2, wherein vehicle movement is impeded by damage caused to the vehicle by the atmospheric overpressure.

6. The method of claim 2, wherein vehicle movement is impeded by damage caused to a road traveled by the vehicle by the atmospheric overpressure.

7. The method of claim 2, wherein movement is delayed or costs are increased.
